(19) United States
(12) Patent Application Publication
(10) Pub. No.: US 2011/0172989 A1
(43) Pub. Date: Jul. 14, 2011

(54) INTELLIGENT AND PARSIMONIOUS MESSAGE ENGINE

(76) Inventor: Ian M. Moraes, Suwanee, GA (US)

(21) Appl. No.: 12/685,831

(22) Filed: Jan. 12, 2010

(51) Int. Cl. G06F 17/27; G06Q 30/00

(52) U.S. Cl. 704/9; 705/14.49; 704/260

(57) ABSTRACT

A message engine for analyzing or examining a message and generating a textual description of the message. The message engine can provide a textual description of a voice message. The message engine does not present a speech to text conversion of the complete voice message (that is, it does not convert the entire message to text and present the textual version of the entire voice message to the user). Rather, the message engine presents only the conceptual key words that describe the essence of the voice message to the user. As such, the message engine is a more intelligent version of a speech-to-text convertor. An exemplary message engine will only present in text the key conceptual words of the message rather than the entire speech to text translation of the whole message.

### CROSS-REFERENCE TO RELATED APPLICATIONS

This application is related to the U.S. patent application assigned Ser. No. 12/335,967 filed on Dec. 16, 2008 and bearing the title of MESSAGE ROBOT, which application is hereby incorporated by reference in its entirety.

### BACKGROUND

Speech-to-text and text-to-speech converters have been used in a variety of settings for a variety of purposes. In general, there are times when it is more convenient to have text messages available in speech form and vice versa. For instance, a speech-to-text converter is extremely useful in converting dictation into text for creating documents or for limiting the amount of storage required for the content. In addition, converting text content into speech is useful for environments in which reading is not convenient, impracticable or impossible (such as for the blind or while driving).

The techniques employed for speech to text conversion are well known in the art and is generally referred to as speech recognition. Speech recognition is the process of converting an acoustic signal or a digitized version of the acoustic signal, captured by a microphone, telephone, etc., into a set of words. The recognized words can be the final results, as for applications such as commands & control, data entry, and document preparation. They can also serve as the input to further linguistic processing in order to achieve speech understanding.

Speech recognition systems can be characterized by many parameters. An isolated-word speech recognition system requires that the speaker pause briefly between words, whereas a continuous speech recognition system does not. Spontaneous, or extemporaneously generated, speech contains variations, and is much more difficult to recognize than speech read from script. Some systems require speaker enrollment in which a user must provide samples of his or her speech before using them, whereas other systems are said to be speaker-independent, in that no enrollment is necessary. Some of the parameters depend on the specific task. Recognition is generally more difficult when vocabularies are large or have many similar-sounding words. When speech is produced in a sequence of words, language models or artificial grammars are used to restrict the combination of words.

The simplest language model can be specified as a finite-state network, where the permissible words following each word are given explicitly. More general language models approximating natural language are specified in terms of a context-sensitive grammar.

Speech recognition is a difficult problem, largely because of the many sources of variability associated with the signal. First, the acoustic realizations of phonemes, the smallest sound units of which words are composed, are highly dependent on the context in which they appear. These phonetic variations are exemplified by the acoustic differences of the phoneme. In addition, at word boundaries, contextual variations can be quite dramatic resulting in word smearing.

In addition, acoustic variations can result from changes in the environment as well as in the position and characteristics of the transducer. Also, within-speaker variations can result from changes in the speaker's physical and emotional state, speaking rate, or voice quality. Finally, differences in sociolinguistic background, dialect, and vocal tract size and shape can contribute to variations across several speakers.

As a result, much research has gone into the technologies focused on performing speech to text conversions. Those skilled in the art will be well versed in the various techniques, anomalies, and processing methodologies for this technology.

In the information age in which we live, we are constantly bombarded with information in a variety of settings, including voice mails, text messages, RSS feeds, emails, TWITTER posts, FACEBOOK status update, MYSPACE posts, blog updates, etc. For instance, in an article by the Radicat Group cited in the WALL STREET JOURNAL on Nov. 27, 2007, the statistics and projections on the average number of corporate emails sent and received per person per day was listed as:
2007: 142
2008: 156
2009: 177
2010: 199
2011: 228

One can easily see that when you combine this with the knowledge of the length of the emails, along with voice messages, text and other forms of communications, it is a wonder that we do anything other than deal with messages all day.

What is needed in the art is a technique to enable message recipients to quickly see what the gist of a message is about without having to actually read the entire message. Furthermore, because of the huge influx of messages, it can often times be very difficult to find an earlier message and access it for responding or otherwise. Thus, there is also a need in the art for a technique to identify key words in a message that can be used for indexing, searching, sorting or filing the messages for later recall.

Because messages come in a wide variety of formats, including textual and speech, what is needed in the art is a technique to provide message summaries regardless of the original medium or format. Further, because of the complexities associated with speech to text conversion as presented above, what is needed in the art is a technique that can provide the summary information without having to perform a full speech to text conversion on a voice based message.

### BRIEF SUMMARY

The present disclosure address the above-identified needs in the art, as well as other needs by presenting an engine, system, apparatus and method (collectively referred to as a message engine) for analyzing or examining a message and generating a textual description of the message. More particularly, one embodiment of the message engine provides a textual description of a voice message. The message engine does not present a speech to text conversion of the complete voice message (that is, it does not convert the entire message to text and present the textual version of the entire voice message to the user). Rather, the message engine presents only the conceptual key words that describe the essence of the voice message to the user.

As such, the message engine is a more intelligent version of a speech-to-text convertor. An exemplary message engine will only present in text the key conceptual words of the message rather than the entire speech to text translation of the whole message. As in example, the following text represents a sample of a voice message that may be operated on by an exemplary embodiment of the message engine:
“Hi Chris, What's up? Hope you are doing okay. I am just hanging out, waiting for you. Please call me when you get this message. Ann”

An exemplary embodiment of the message engine would analyze the received message and may only present the following textual summary to the recipient:
“Please call me back, Ann.”

More specifically, an exemplary embodiment of the message engine, which may also reside in a message handling system, includes a speech recognition component configured to convert a voice message into a raw text message. The speech recognition component may operate in conjunction with a grammar that consists of a standard grammar and/or user augmentations to the grammar. The grammar may be configured to recognize certain content types, such as addressing or contact information, telephone numbers, email addresses, websites, etc. Further, a post processor component is configured to modify the raw text message by recognizing common sounds and structures in the raw text message and modifying it to create a processed text message. The post processor can operate to modify the raw text messages by identifying and removing repetitions, pauses, and matching utterances with a list of commonly used utterances. For instance, the list of commonly used utterances may include utterances to be filtered and, the post-processing component then removes the utterances from the processed text message that match an utterance to be filtered out. A template recognition component is configured to identify patterns within the text message and match these patterns with one or more templates retrieved from a template database. The template recognition component may be configured as a filter (removing unwanted text), a validation process (identifying and passing desired text) or a combination of both. A knowledge-base component configured to identify conceptual key tokens (which may be a word, a phonetic, a phrase, etc) in the message based on a rule base set. For example, the knowledge-base component may operate to replace conceptual key tokens with summary tokens. An output component is configured to present the conceptual key tokens extracted from the message.

The output from the message engine may be used to drive a variety of application or devices. For instance, the output may be provided to a message mediator which operates to format the message for further posting or delivery.

In addition, the output may be provided to a visual voice mail system that operates to create summaries of the messages and present the summaries to a user visually.

As another example, the output may be provided to an advertising server to provide key words to the advertising server to trigger the production of relevant advertisements. As another example, the output could be received by a message robot that receives conceptual key words, parses the words to identify actions to be invoked, and then takes action based on the key words.

### BRIEF DESCRIPTION OF THE SEVERAL VIEWS OF THE DRAWING

FIG. 1 is a functional block diagram and flow diagram illustrating the conceptual operation of an exemplary message engine.

FIG. 2 is a general block diagram illustrating a hardware/system environment suitable for various embodiments or embodiments of components of the dynamic network planner and cost estimator.

FIGS. 3A and 3B, collectively referred to as FIG. 3, represents a flow diagram of a received voice message and the states of the output as the voice message is processed by an embodiment of the message engine.

### DETAILED DESCRIPTION OF EMBODIMENTS

The present disclosure presents various embodiments, as well as features and aspects thereof, of a technique for identifying or developing an “essence of the message” summary for various types of message. The technique can be embodied in a method, system, apparatus, engine, module, routine, etc. and will be collectively referred to as a message engine. The various embodiments of the message engine operate user or operator autonomously, meaning that the technique does not require or depend on human transcription services.

More particularly, one embodiment of the message engine provides a textual description of a voice message. The message engine does not present a speech to text conversion of the complete voice message (that is, it does not convert the entire message to text and present the textual version of the entire voice message to the user). Rather, the message engine presents only the conceptual key words that describe the essence of the voice message to the user. Other embodiments may operate on textual message, video messages, or a hybrid of two or more of these types.

As a further example, a typical environment for embodiments of the message engine is within a voice mail notification system in which a user or recipient is notified that a voice mail has been received via a text message or an SMS (short message service) message. An embodiment of the message engine may present a textual description of a voice message within an SMS (short message service) notification of a typical new voice mail message. The notification message provided by the message engine is simply used to describe the essence of the message and may also help to identify the message when presented with a list of message headers. Advantageously, this aspect of the message engine allows a user to identify the essence of a message without having to call into the system to play that particular voice message. An added benefit of this aspect is that is reduces telephony ports required by operators and reduces the length of the SMS that needs to be sent out to the user. As such, from a user's perspective, time is saved in the reading and understanding of the message (i.e., it is easier and quicker to read the summary than to access and listen to the whole voice message or, parse through an entire speech-to-text conversion of the voice message) and, memory utilized and texting charges are reduced. and is easier than having to read the entire message.

Embodiments of the message engine can also be used to present a summary of a message (such as a voice message) within a visual list of the message headers in a user's mailbox. This aspect is advantageous because the user can quickly identify the message and, the user is able to perform an action (e.g., forward the right message) without having to play that particular message. Another advantage of this aspect of the message engine is realized when a user cannot conveniently or appropriately play and/or listen to a voice message. For instance, if a user is in a meeting or other setting and using a speaker phone or using a mobile is not context appropriate. Also, in a web display the latency and data charges associated with retrieving the message may be an issue.

Other embodiments of the message engine can be used in an advertising-enabled environment. In such an environment, the conceptual key words identified to represent the essence of a message can be used to present a more targeted advertisement on a per message and per session basis. An example might be the following. A voice message is left such as “Hey do you want to go to the Jayhawks bowl game?” As a result, when the message is delivered as conceptual key words to the recipient, ads relating to Kansas Jayhawks web sites, TicketMaster, Airline and Hotels can be presented to the subscriber.

Yet in other embodiment, the key words extracted or presented by the message engine can be used to provide intelligent assistance and automated responses back to the user. For example, if the message is “are you in the office”, an automated response leveraging the recipient's schedule and presence detectors could be used to identify the message and respond to the sender of the message with an appropriate response, such as “In meetings all afternoon” or “Travelling, back in the office on Monday”.

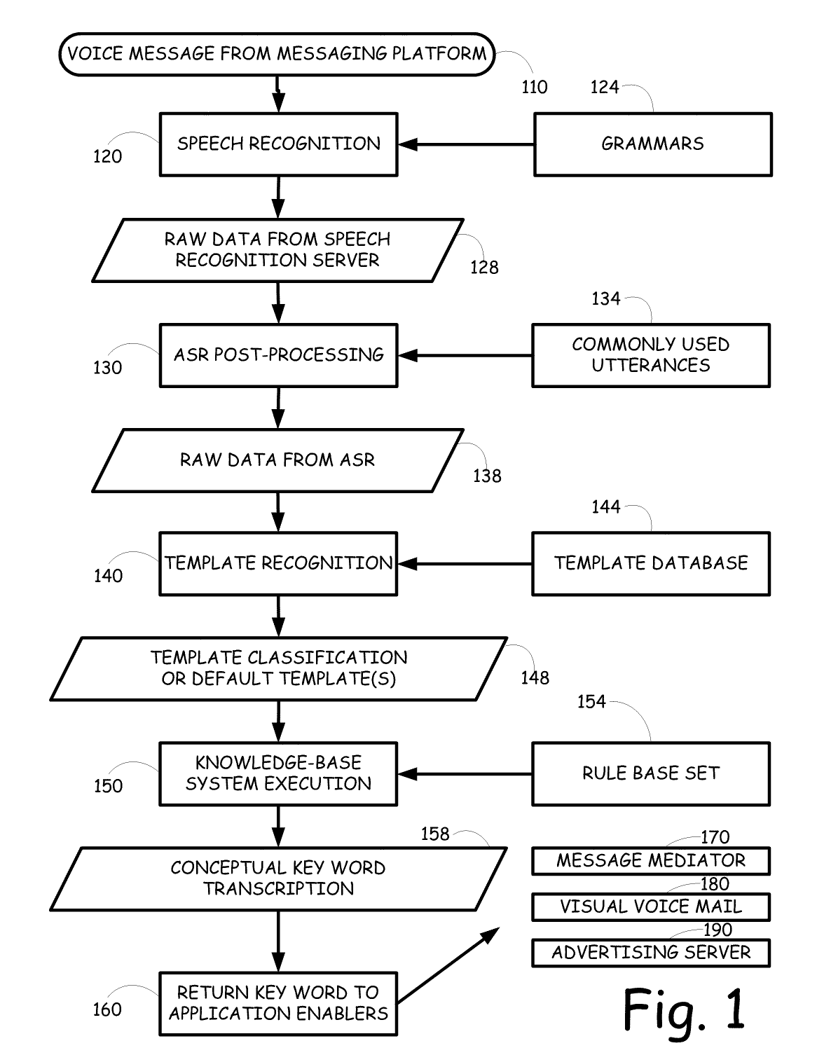

FIG. 1 is a functional block diagram and flow diagram illustrating the conceptual operation of an exemplary message engine. In general, an embodiment of the message engine operates to convert a voice mail message to text (VMTT) in terms of conceptual key word descriptions. It should be noted that the message engine can operate independent of interaction with a human transcriber. It is an advantage of various embodiments of the message engine that human intervention is not required for converting the message or to identify or describe the essence of the message.

In operation of an exemplary embodiment, a voice message is sent to, received by or accessed by the message engine in a standard file format (e.g., WAV, G.711 or other) using a standard protocol (e.g., SOAP) and the conceptual key words for the message is generated by the message engine. This is illustrated in FIG. 1 as receiving a voice message from a messaging platform 110.

Speech Recognition. At the onset, a speech recognition component 120 within the message engine operates to convert the speech to text. In an exemplary embodiment, this can be performed by leveraging a commercially available or proprietary speech recognition engine to convert the speech to text. Standards based on VoiceXML, Media Resource Control Protocol (MRCP) and Speech Recognition Grammar Specification (SRGS) can be leveraged to perform this step. Grammars 125 can be developed based on the most frequently used words in voice messages for a specific language and locale. For instance, in one embodiment the top 300 words can be identified based on usage. The grammar 124 may also comprise rules for identifying telephone numbers (locale-specific) or other standard and common inputs including, but not limited to email addresses, mailing addresses, salutations, etc. In addition, the grammar 125 may have rules to identify words that are slang, or that are spoken version of numbers or letters (i.e., one, two, ex, em, tee, etc.) Further, in the United States market, the grammar 125 may also identify a standard set of grammars composed of voice mail pertinent words such as, call, back, later, talk, you, please, me). Then, optionally, a solution provider can add other locale-specific and event-specific words to the grammar such as, soccer, fire, bombing, etc. Thus, the grammar may then consist of a standard set of grammar and additional grammar that is added by the end user. The additional grammar component should be more fluid and easy to be changed. The grammar 124 is provided as input to the speech recognition component 120, along with the voice message to generate raw recognition from the speech recognition server 128. It should be appreciated that this operation of the message engine could also include operating on video messages and performing image recognition. For example, for video messages, an embodiment may operate to leverage cues in the video to post-process the transcription. Cues in the video are leveraged from an image recognition database. For example, if you are calling from a football game, the football field and stadium name could be recognized cue to provide context for the video message.

ASR Post-Processing. The automatic speech recognition (ASR) post-processing component 130 operates to clean up the transcription 128 provided as output from the speech recognition component 120. One of the goals or functions of the ASR post-processing component 130 is to increase the efficacy of the following steps or operations in the message engine. The clean up process can include a variety of functions or operations. The ASR post-processing may be an off the shelf (OTS) component, a proprietary component or a hybrid of both, and operate in conjunction with a defined database of adjustments, refinements, etc., such as a database of commonly used utterances 134. As a non-limiting example, the ASR post-processing component 130 may operate to remove repetitions, pauses, utterances (i.e., um, er, uh, etc.), identifying telephone numbers versus other numbers such as bank accounts, etc. The ASR post-processing component 130 also may operate to refine the textual descriptions, such as representing 4352343440 as (435) 234-3440. The ASR post-processing component may include more sophisticated functions such as identifying moods or tones, etc. For example, if the caller uses bad language or uses certain terms (“I hate you when you are late”), this could be used to infer the mood of the caller (e.g., the caller is upset).

The ASR post-processing component may also be extended to work with video messages. For example, for video messages, the procedure can leverage cues in the video to post-process the transcription. For example, if a caller is calling from a football game, the football field cue would provide more context for the utterance “80 yard bomb.” Facial clues can also provide context for inferring mood of caller.

Upon completion of the ASR post-processing component 130 operation, the raw data from the ASR 138 is presented to the template recognition component 140.

Template Recognition. The template recognition component 140 utilizes templates to focus in on the core essence of the message. For instance, the fluff or non-critical portions of the message that convey minimal or no relevant information are removed from the raw data 138 presented from the ASR post processing component 130.

In an exemplary embodiment, a database containing a set of templates 144 may be maintained and provided as input to the template recognition component 140. Employing fuzzy set theory, fuzzy logic, pattern recognition, artificial intelligence, statistics and/or simply a set of heuristics, or a combination of one or more of these types will be used to match a message to a template type. As a non-limiting example, exemplary templates can be constructed as follows:
<Salutation> such as Hi, Hello, Good Morning, This is me, etc.
<Indication to return call> such as can you call me back, give me a buzz, etc.
<sign-off> such as later, catch ya, see you, bye, buhbuy, thank you, I look forward to etc.

If a template cannot be found then a default template is used.

In operation of an exemplary template recognition component 140, the raw data from the ASR can be parsed and compared to the available templates in the template database. A match can be based on a variety of factors including the identified characters and/or words, the location of the words within the message, the context of the words, etc. In one embodiment, the various elements that are identified as matching with a template can then be removed from the raw data 138 and presented as output from the template recognition component 140 as template filtered data provided to the knowledge-base system execution component 150. In other embodiments, the identified template or templates, along with the raw data from the ASR 138 may be presented as output 148 to the knowledge-based system execution component 150.

Also, depending on the various embodiments of the message engine, complex templates may be used to characterize an overall message structure or, a series of more simple templates may be used to characterize certain portions of the message. As such, a single message may be associated with a single template that identifies the salutation, body, call request, signing-off statement, etc. Or, a message can be associated with a set of templates for each of these components and, if any text is not associated with a template, then that text can be associated with an unknown template.

In addition, some templates may be identified as extraneous or unnecessary information and some as pertinent information. As such, the text that is associated with an extraneous information template may be filtered at this stage whereas the text associated with a pertinent template may be passed on to the knowledge-based system execution component 150.

Knowledge-based System Execution. The knowledge-based system component 150 operates on input from the template recognition component 140 and a rule base set 154. The knowledge-based system component 150 includes an inference engine mechanism that iterates over the rule base set 154. The knowledge-based system component 150 determines a conceptual key word/phrase 158 from the core essence using a set of rules. A few non-limiting examples of rules include:
If core essence is <call me back later> then conceptual key word is <call me>
If core essence is <give me a buzz when you can> then conceptual key word is <call me>

Knowledge-based systems, to be most effective, should be able to reason in the presence of uncertainty. For instance, in some situations, all the words may not be recognized, context may not be available, terms may be ambiguous, etc. As such, the knowledge-based system execution component 150 can also leverage techniques such as Bayesian networks, rough sets, and fuzzy set theory as a means to deal with uncertainty.

To further illustrate the operation of various embodiments, the following simple example of a voice message being processed is presented.

Hi John, Umm This is Karen Uhh Call me back later

Here are some concrete rules that help to illustrate the processing.

If <hi|hello|hey> and <name> then phrase is very likely salutation

If <salutation processed> then <process_caller_identification>

If <process_caller_identification> and <<this is> and <name>> or <name> and <here|calling> then phrase is very likely caller identification

If <call me back|call me|give me a call> then phrase is very likely sign-off

If <salutation processed> and <sign-off> then <short msg template 1>

If <salutation processed> and <caller identification> and <sign-off> then <short msg template 2>

If <<short msg template 2> or <short msg template 1>> and <phrase is sign off> then conceptual key word is very likely <call me>

It should be appreciated that the rule base set 154, as well as the grammars 124, commonly used utterances database 134 and the template database 144 can be customer, industry or otherwise based. For instance, in a particular industry or locale, certain terms, phrases, and information may be expected and as such, these components can be customized to support that industry or locale.

Return Key-Word to Application Enablers. Once the conceptual key word description is available it may be customized before being returned to a specific application enabler. The process of returning a key-word or key-phrase to an application enabler 160 can take on a variety of forms and trigger a variety of actions. For example, if the conceptual key word description is being directed to message mediator 170, such as an SMS generator or other message generator. Here, the message engine can trim the resulting description down to a size that is appropriate for the delivery of the message (i.e, 160 characters for SMS, 140 characters for a TWITTER post, 450 characters for a FACEBOOK post, etc.)

As another example, the key-words/phrases can be fed to a visual voice mail system 180. In this context, the visual mail components 180 can leverage conceptual key words/phrases to enable searching a folder or list of voice messages, sorting or categorizing a set of voice messages, etc. Visual mail subscriber can also view conceptual key words when listening to the voice mail is not possible (e.g., in a meeting).

As another example, the key-words or phrases may be fed as input to an advertising server 190. The advertising server 180 can examine the presented words/phrases and use the input to determine what advertisements to present based on the message context described in the conceptual key word/phrase description.

As yet another example, the conceptual key words/phrases can also be used to support a message robot that receives messages, parses the messages to identify actions to be invoked from the messages, and then takes such action. U.S. application for patent Ser. No. 12/335,967 filed on Dec. 16, 2008 describes a system that can receive and operate on such input.

And yet another example is a lawful intercept system component that can leverage conceptual key words/phrases to monitor voice messages without requiring each message to be listened to by a human transcriber.

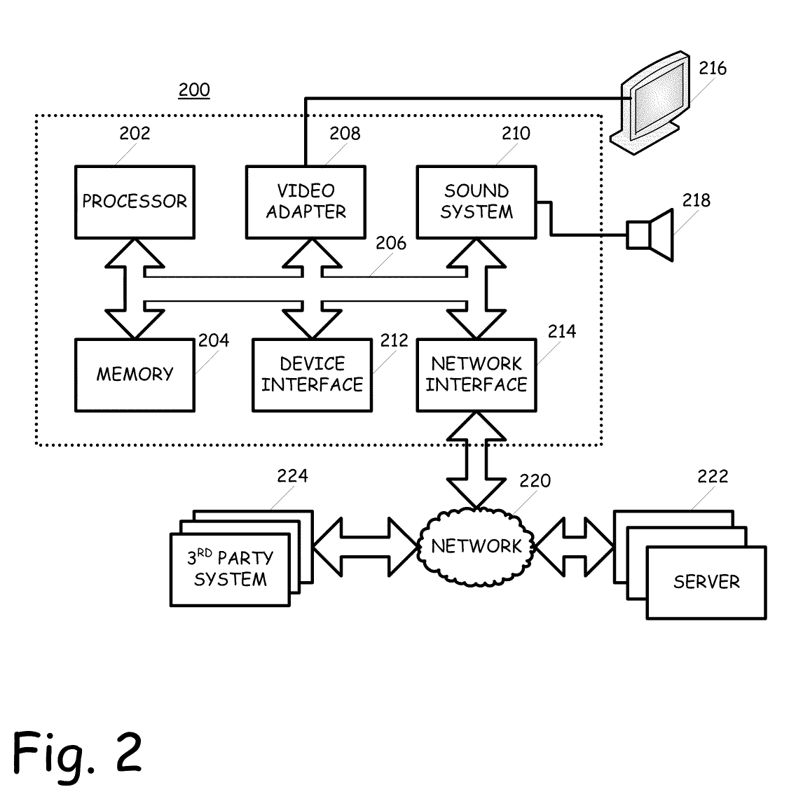

FIG. 2 is a general block diagram illustrating a hardware/system environment suitable for various embodiments or embodiments of components of the dynamic network planner and cost estimator. A general computing platform 200 is shown as including a processor 202 that interfaces with a memory device 204 over a bus or similar interface 206. The processor 202 can be a variety of processor types including microprocessors, micro-controllers, programmable arrays, custom IC's etc. and may also include single or multiple processors with or without accelerators or the like. The memory element 204 may include a variety of structures, including but not limited to RAM, ROM, magnetic media, optical media, bubble memory, FLASH memory, EPROM, EEPROM, etc. The processor 202 also interfaces to a variety of elements including a video adapter 208, sound system 210, device interface 212 and network interface 214. The video adapter 208 is used to drive a display, monitor or dumb terminal 216. The sound system 210 interfaces to and drives a speaker or speaker system 218. The device interface 212 may interface to a variety of devices (not shown) such as a keyboard, a mouse, a pin pad, and audio activate device, a PS3 or other game controller, as well as a variety of the many other available input and output devices. The network interface 214 is used to interface the computing platform 200 to other devices through a network 220. The network may be a local network, a wide area network, a global network such as the Internet, or any of a variety of other configurations including hybrids, etc. The network interface may be a wired interface or a wireless interface. The computing platform 200 is shown as interfacing to a server 222 and a third party system 224 through the network 220.

Returning to the example in which the conceptual key words/phrases can be used to support a message robot, in FIG. 2, for example, the message engine could be incorporated into computing platform 200 and the robot could exist on a third party system 224 or server 222 or be accessible over a variety of network interfaces 214.

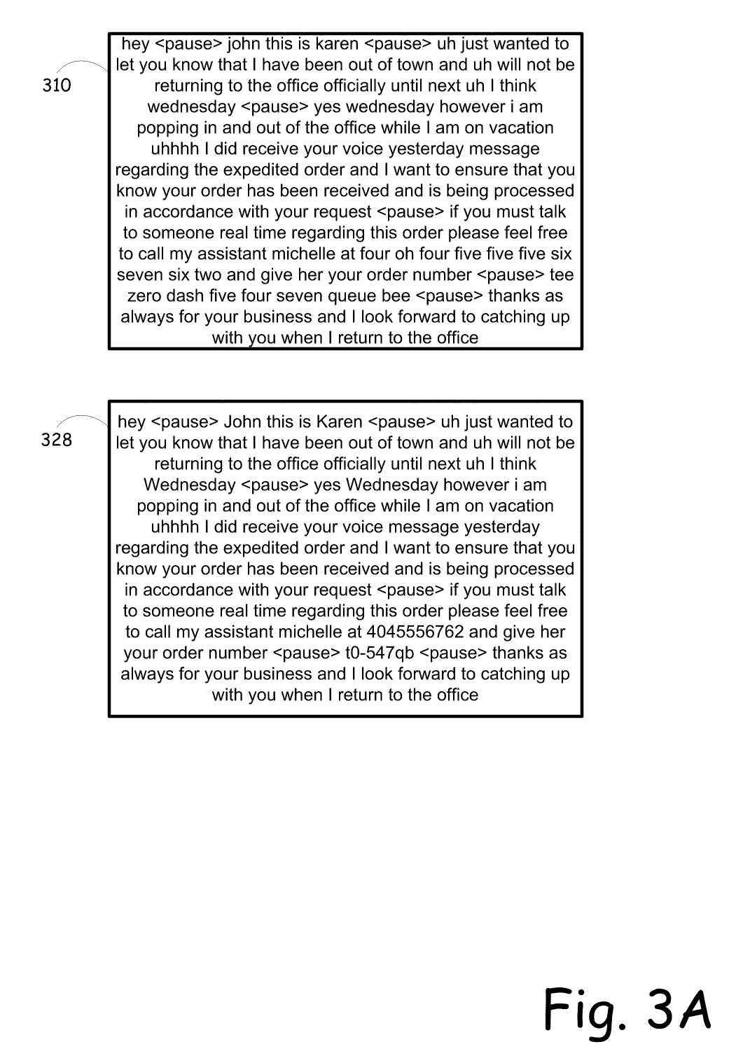

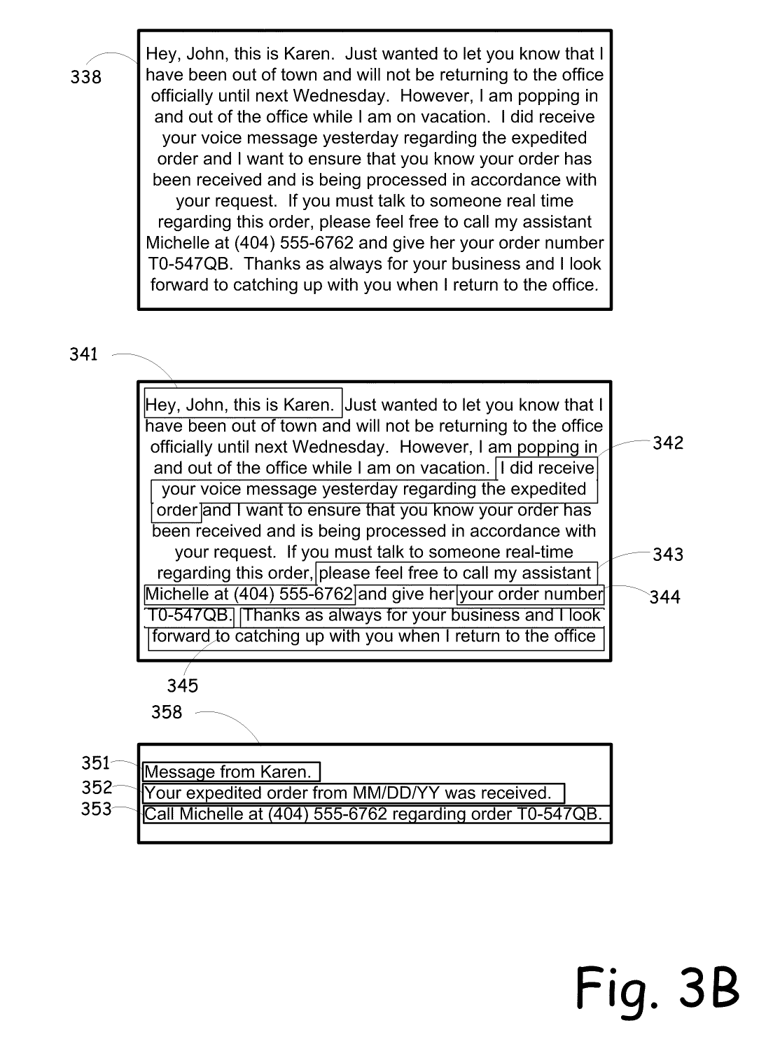

To further the understanding of the various embodiments of the message engine and the features, aspects and advantages thereof, a few examples are provided. FIGS. 3A and 3B, collectively referred to as FIG. 3, represents a flow diagram of a received voice message and the states of the output as the voice message is processed by an embodiment of the message engine. The processing of the voice message as shown in FIG. 3 is described in conjunction with the functions illustrated in FIG. 1.

Initially a voice message is received, retrieved or otherwise selected to be processed by the message engine. The raw voice data is represented in textual form in block 310 but should be appreciated that in the illustration, this is actual voice data. Portions of silence are shown in the voice message as <pause>.

The voice message is processed by the speech recognition component 120, along with any appropriate grammars 124 to obtain the raw data 328. The raw data 328 is now a textual version of the voice message with actual pauses in the voice message 310 being represented by the <pause> textual place holders in the raw text 328. By examining the data, it is shown that the numeric utterances have been converted to textual numbers and proper nouns, such as John, Karen and Wednesday have been identified by the grammar.

The raw data 328 is then processed by the ASR post-processing component 130 to generate the raw data from the ASR 338. The ASR post-processing component 130 utilizes the list of common utterances, as well as identifying pauses and cadences to create sentence structure for the raw text 338. For instance, a pause, an uh utterance, a prolonged uh utterance, a combination of a pause and an uh utterance can all indicate the end of a sentence or a comma. The length of the pause can be examined to help determine if the pause should be a comma or a period. As such, in some embodiments the raw data from the speech recognition component 120 may include not only a pause indicator, but also identify the length of the pause.

The ASR post-processing component 130 has also identified the phrase “I think Wednesday yes Wednesday” as being repetitive and has replaced this with “Wednesday”.

Next, the template recognition component 140 operates on the raw data 338 from the ASR post-processing component 130 to identify types of data structure within the message by comparing the data to a list of templates in the template database 144. This process can be accomplished in a variety of manners relying on a wide range of template types and data and as such, the present example is simply for illustrative purposes. In the illustrated example, several templates are associated with phrases in the textual message. For instance, the following exemplary template matches are illustrated:
a salutation template 341 is associated the phrase “Hey, John, this is Karen”;
a message acknowledgement template 342 is associated with the phrase “I did receive your voice message yesterday regarding the expedited order”;
a call indication template 343 is associated with the phrase “please feel free to call my assistant Michelle at (404) 555-6762”;
a order number template 344 is associated with the phrase “your order number TO-547QB”; and
a sign-off template 345 is associated with the phrase “Thanks as always for your business and I look forward to catching up with you when I return to the office”.

The knowledge-base component 150 now operates on the massaged textual data message in voice of the identified templates and a rule base set 154 to generate a conceptual key word, words or phrases to be presented as the essence of the message. In the illustrated example, the key words/phrases 358 extracted by the knowledge-base component 150 include the following:
Message from Karen 351—here the phrase “Hey, John, this is Karen” has been reduced to the simple indication that this is a message from Karen. Because John is receiving the message, it is not necessary to identify him as the recipient in the text and the colloquial salutation of “Hey . . . this is Karen” has been converted to the essence of the phrase which is “Message from Karen.
Your expedited order from MM/DD/YY was received 352—here the phrase “I did receive your voice message yesterday regarding the expedited order” has been reduced. The term “yesterday” has been replaced with an actual date. This was accomplished through having knowledge of the date that the current message was prepared and then applying that date to the term “yesterday”. Further, because the term “message” was qualified as being about, or regarding an expedited order, this phrase was reduced to focus only on the expedited order rather than the message.
Call Michelle at (404) 555-6762 regarding order T0-547QB 353—the phrase “please feel free to call my assistant Michelle at (404) 555-6762” is shown as being reduced, as well as combined with the reduced phrase “your order number T0-547QB”. In essence, John is instructed to call Michelle regarding the order number, T0-547QB which is contextually shown as being related to the “expedited order”.

Finally, the phrase “Thanks as always for your business and I look forward to catching up with you when I return to the office has been removed from the message as an unnecessary sign-off message. In addition, the remaining elements of the message have also been removed as not conveying the essence of the message. It should be noted that different rules may be applied to derive a different message. For instance, in some embodiments, the terms “out of town”, “returning to office”, “until next Wednesday” etc., may be considered as important and could be synthesized to convey the message of “I am out of the office until MM/DD/YY”.

Although the primary examples have been described as operating on voice messages, it will be appreciated that the various embodiments, features and aspects of the message engine may also be applied to text messages, video messages, etc. For instance, with a text message, such as an email, an SMS message or other text-based message, the message engine could consider the text message as raw data from the ASR and begin processing of the message from the template recognition component 170. In such embodiments, the message engine could reside within an email utility, such as MISCROSOFT OUTLOOK, a message receiving device such as a BLACKBERRY or iPHONE, a message server such as the MICROSOFT EXCHANGE SERVER, etc.

Other embodiments may operate to process video messages. In such embodiments, the grammars and common utterances may be video based. For instance, certain video content can be recognized and matched with a library of video content, such as stadiums, buildings, etc. Further, textual backgrounds in a video message can be analyzed to help identify the location or context of the video. The video message may also obviously include audio content which could simply be processed as previously described either exclusively or in addition to the video content. Similarly, the video content may be analyzed exclusive of the audio content.

It should also be appreciated that the message engine could process voice messages, text messages, audio content, web-based content, video messages, etc., to identify content to be included into a blog or message forum, or even within a GOOGLE WAVE.

In some embodiments, the message engine may allow the end user to define, augment or select various grammars, common utterances, templates and rule base sets to apply to the messages. In such embodiments, a user can create robust message handling systems that can sort, summarize, automatically respond to, and process a wide variety of message types.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A message handler comprising:
a speech recognition component configured to convert a voice message into a raw text message;
a post processor component configured to modify the raw text message by recognizing common sounds and structures in the raw text message and modifying to create a processed text message;
a template recognition component configured to identify patterns within the text message and match the patterns with one or more templates retrieved from a template database;
a knowledge-base component configured to identify conceptual key tokens in the message based on a rule base set; and
an output component configured to present the conceptual key tokens extracted from the message.

2. The message handler of claim 1, wherein the template database includes extraneous word templates and, the template recognition component is configured to remove text from the processed text message that matches an extraneous word template.

3. The message handler of claim 1, wherein the template database includes extraneous word templates and, the template recognition component is configured to identify text in the processed text message that matches an extraneous word template and, the knowledge-base component is further configured to remove text from the processed text message that matches an extraneous word template.

4. The message handler of claim 3, wherein the post processor component if configured to modify the raw text messages by identifying and removing repetitions, pauses, and matching utterances with a list of commonly used utterances.

5. The message handler of claim 4, wherein the list of commonly used utterances includes utterances to be filtered and, the post-processing component is further configured to remove utterances from the processed text message that match an utterance to be filtered out.

6. The message handler of claim 1, wherein the knowledge-base component is further configured to replace conceptual key tokens with summary tokens.

7. The message handler of claim 1, wherein the speech recognition component is further configured to operate in conjunction with a grammar that consists of a standard grammar and user augmentations to the grammar.

8. The message handler of claim 1, wherein the grammar can recognize contact information.

9. The message handler of claim 1, wherein the output component interfaces to a message mediator for formatting the message for further posting.

10. The message handler of claim 1, wherein the output component interfaces to a visual voice mail system and is configured to create summaries of the messages and present the summaries to a user visually.

11. The message handler of claim 1, wherein the output component interfaces to an advertising server and is configured to provide key words to the advertising server to trigger the production of relevant advertisements.

12. A system for receiving messages and creating shortened messages that substantially convey the meaning of the message, the system comprising:
a memory element for receiving and storing a grammar list, a list of commonly used utterances, a template database and a rule base set;
a message source interface for receiving a message;
an application output interface;
a message engine for processing the message, the message engine being configured to:
parse a textual message and identify patterns within the text message and match the patterns with one or more templates retrieved from a template database or associate the text with an unknown template;
identify conceptual key tokens in the message based on a rule base set; and
present the conceptual key tokens extracted from the message to the application output interface.

13. The system of claim 12, wherein the message engine is further configured to:
receive a voice message from the message source interface; and
convert the voice message to a textual message.

14. The system of claim 14, wherein the message engine is configured to convert the voice message to a textual message by
utilizing a speech recognition component configured to convert the voice message into a raw text message;
utilizing a post-processor component configured to modify the raw text message by recognizing common sounds and structures in the raw text message and modifying to create a processed text message;

15. The message handler of claim 14, wherein the template database includes extraneous word templates and, the template recognition component is configured to remove text from the processed text message that matches an extraneous word template.

16. The message handler of claim 14, wherein the template database includes extraneous word templates and, the template recognition component is configured to identify text in the processed text message that matches an extraneous word template and, the knowledge-base component is further configured to remove text from the processed text message that matches an extraneous word template.

17. A method for receiving messages and creating shortened messages that substantially convey the meaning of the message, the system comprising:
receiving a template database and a rule base set and storing them into a memory element;
parsing a textual message to identify patterns within the textual message;
matching the patterns with one or more templates retrieved from a template database or associate the text with an unknown template;
identifying conceptual key tokens in the message based on a rule base set; and
presenting the conceptual key tokens extracted from the message to an application output interface.

18. The method of claim 17, further comprising receiving a grammar list and a list of commonly used utterances and storing them into the memory element;
receiving a voice message from a message source; and
converting the voice message into the textual message.

19. The method of claim 18, wherein the step of converting the voice message into the textual message further comprises the steps of:
performing a speech recognition process on the voice message to convert the voice message into a raw text message;
performing a post-processor process to modify the raw text message by recognizing common sounds and structures in the raw text message and modifying to create a processed text message.

20. The method of claim 19, wherein the template database includes extraneous word templates and further comprising the step of:
removing text from the processed text message that matches an extraneous word template.
